(19) United States
(12) Patent Application Publication
(10) Pub. No.: US 2002/0048061 A1
(43) Pub. Date: Apr. 25, 2002

(54) Method and apparatus for improving the signal quality of a modulated optical transmission signal

(76) Inventors: Christoph Glingener, Feldkirchen-Westerham (DE); Erich Gottwald, Holzkirchen (DE)

Correspondence Address: BELL, BOYD & LLOYD, LLC, P. O. BOX 1135, CHICAGO, IL, 60690-1135, US

(21) Appl. No.: 09/960,782

(22) Filed: Sep. 21, 2001

(30) Foreign Application Priority Data
Sep. 21, 2000 (DE) 100 46 941.8

(51) Int. Cl. H04B 10/08; H04B 10/00

(52) U.S. Cl. 359/110; 359/161

(57) ABSTRACT

A method and apparatus for improving the signal quality of a modulated optical transmission signal wherein at least one optical signal whose frequency is reduced from the carrier signal frequency by the Brillouin frequency shift is produced in a signal production unit and this signal is injected at the end of the optical transmission fiber in the opposite direction to the transmission signal direction, so that the carrier signal component of the modulated optical transmission signal is reduced.

### BACKGROUND OF THE INVENTION

In optical transmission systems with data rates of 20 Gbps or more, a low extinction ratio for digital amplitude-modulated optical signals or transmission signals, in particular in optical long-distance systems with optical amplifiers, makes a considerable contribution to a deterioration in the optical signal-to-noise ratio (OSNR) required for reconstructing the data at the receiving end. The extinction ratio is obtained from the power ratio between the logic 0 signal power level and the logic 1 signal power level. That is, an amplitude-modulated signal with a high continuous wave component or carrier signal component which is greater than half the total power level of the optical transmission signal has a low extinction ratio, and a virtually 100% modulated signal has a very high extinction ratio.

In amplitude-modulated optical transmission signals, the signal quality of the optical signal can be improved considerably by specific filtering of, or reducing, the carrier signal. The extinction ratio of the amplitude-modulated optical transmission signal is thus increased, and hence the requirements for the signal-to-noise ratio of the amplitude-modulated optical transmission signal are considerably reduced. Any reduction in the signal-to-noise ratio results in an increase in the transmission range which can be bridged without regeneration or else in the influence of disturbing nonlinear effects being minimized since the transmission level can be reduced because the requirements are less stringent.

The fact that the stimulated Brillouin scatter (SBS) in optical transmission fibers causes signal distortion of modulated optical transmission signals is known from the publication by H. Kawakami, et al.: “Overmodulation of intensity modulated signals due to stimulated Brillouin Scattering”, Electronic Letters, Sep. 1, 1994, Volume 30, No. 18, pages 1507 to 1509. If, for example, the amplitude or power level of the carrier signal component of the amplitude-modulated optical transmission signal exceeds a critical SBS threshold, then backscatter of the carrier signal component occurs in the direction opposite to the transmission direction in the optical transmission fibers. The frequency of the backscattered carrier signal component is reduced by the “Brillouin shift” or “Stokes shift” of about 10 to 15 GHz owing to the stimulated Brillouin effect; in this context, see also G. P. Argrawal, “Fiber Optic Communications”, John Wiley & Sons INC., 1997, pages 385 to 390. The frequency-shifted backscattered carrier signal component which leads to a reduction in the spectral energy density of the carrier signal component results in overmodulation of the amplitude-modulated optical transmission signal, thus resulting in a deterioration in the “eye opening” of the amplitude-modulated optical transmission signal.

A method for reduction of the carrier signal of a modulated optical “radio-frequency” transmission signal with the aid of stimulated Brillouin scatter is known from the article by S. Tonda-Goldstein, et al: “Stimulated Brillouin scattering for microwave signal modulation depth increase in optical links”, Electronics Letters, May 25, 2000, Volume 36, No. 11, pages 944 to 946, in which the modulated optical transmission signal has an increased DC component or carrier component. The nonlinear effect of “stimulated Brillouin scatter” is used to virtually completely reduce the increased carrier component, on the basis of which an acoustic wave is formed in the transmission direction in the optical fiber or transmission fiber, via which the carrier component of the amplitude-modulated optical transmission signal is backscattered, and is thus reduced. The narrowband nature of the filter effect (approximately a few tens of Megahertz) results in the amplitude of those sidebands, which contain the data information, in the modulated optical transmission signal above the frequencies of a few tens of Megahertz being virtually uninfluenced. Alternatively, suitable coding of the modulated optical transmission signal can be used to suppress those spectral components of the sidebands of the modulated optical transmission signal which are in the range up to a few tens of Megahertz. The method described above can be used to achieve an attenuation of virtually 40 dB in the optical carrier component. The SBS effect produced in the optical fiber results in a portion of the modulated optical transmission signal that is injected into the optical fiber being backscattered, with the backscattered optical signal having a Brillouin frequency shift of about 10 to 15 GHz from the injected modulated optical transmission signal. The backscattered and frequency-shifted optical signal is output at the input of the optical transmission fiber via a circulator, and is injected via a separately arranged optical connecting fiber at the end of the optical transmission path via an optical coupling element having an attenuation of approximately 3 dB. The injected optical signal with a frequency shift of approximately 10 to 15 GHz reinforces the stimulated Brillouin effect in the single-mode fiber whose length is, for example, 10 km. That is, in particular, the acoustic filter (acoustic grating) produced by the SBS effect is enhanced, reducing the carrier component of the amplitude-modulated optical transmission signal. Such feedback of the optical signal that has been frequency-shifted and backscattered by the SBS can be achieved, via an additional feedback fiber, for already existing optical transmission fibers only with a high level of technical complexity and financial cost.

An object to which the present invention is directed is to simplify the improvement in the signal quality of a modulated optical transmission signal having a carrier signal.

### SUMMARY OF THE INVENTION

An major aspect of the method according to the present invention is that at least one optical signal whose frequency is reduced from the carrier signal frequency by the Brillouin frequency shift is produced in a signal production unit and this signal is injected into the optical transmission fiber in the opposite direction to the transmission signal direction, so that the carrier signal of the modulated optical transmission signal is reduced. This advantageously results, for example, in an optical signal being produced at the end of the transmission fiber, which is injected at the end of the optical transmission fiber, in the opposite direction to the transmission signal direction, in order to reinforce the narrowband acoustic gratings formed in the optical transmission fiber. The optical signal or pump signal is thus produced in a simple manner, or is injected in the opposite direction into the optical fiber, at that point in the optical transmission system at which the improvement in the signal quality of the optical modulated transmission signal is intended to be achieved. The backscattered, frequency-shifted optical signal is therefore not fed back via a separately arranged feedback fiber, which needs to be laid as an additional item for already existing optical transmission systems.

A further major aspect of the method according to the present invention is that the frequency difference between the carrier signal and the optical signal is measured, and the frequency of the optical signal is controlled as a function of it. In addition, the frequency and the power level of the optical signal are varied, and are controlled to produce a maximum extinction ratio for the modulated optical transmission signal. The optical signal produced in the signal production unit can be controlled via the control system according to the present invention such that the optical modulated transmission signal has a high extinction ratio.

Additional features and advantages of the present invention are described in, and will be apparent from, the following Detailed Description of the Invention and the Figures.

### BRIEF DESCRIPTION OF THE FIGURES

FIG. 1 shows the basic structure of an optical transmission path with the arrangement according to the present invention for improving the signal quality of a modulated transmission signal.

FIG. 2 shows an alternative embodiment of the arrangement according to the present invention for improving the signal quality of a modulated transmission signal.

FIGS. 3a, 3b each use a graph to show the profile according to the present invention of the drive signals required to vary the frequency of the optical pump signals, plotted against time.

### DETAILED DESCRIPTION OF THE INVENTION

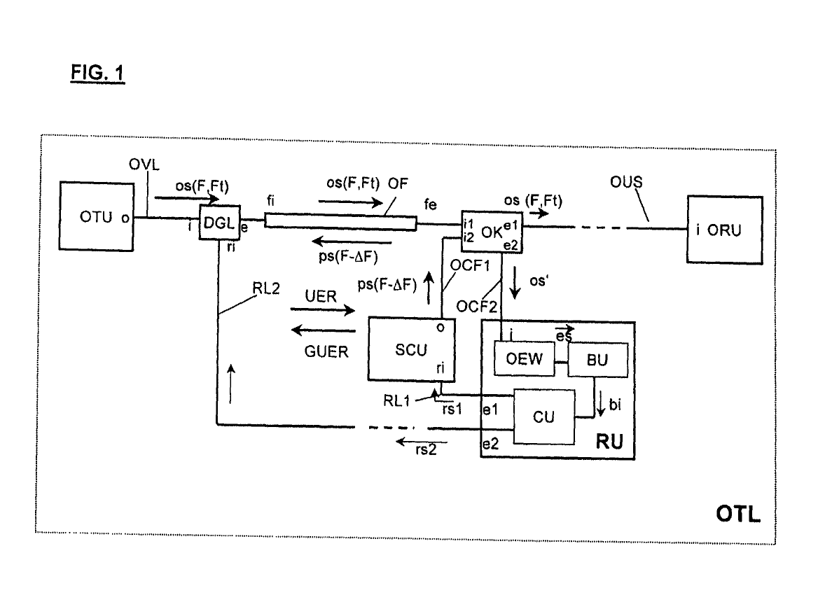

FIG. 1 uses a block diagram, by way of example, to show an optical transmission path OTL, which has an optical transmission unit OTU, an optical receiving unit ORU, a controllable attenuator DGL, an optical fiber or transmission fiber OF as well as an optical coupling unit OK, a signal production unit SCU and a control unit RU. The optical transmission unit OTU has an output o, which is connected via an optical connecting line OVL to the input i of the controllable attenuator DGL. An optical isolator, for example, can be connected (not shown in FIG. 1) between the optical transmission unit OTU and the controllable attenuator DGL. The controllable attenuator DGL has an output e and a control input i, with the control unit RU being connected to the output e of the fiber input fi of the optical transmission fiber OF, and to the control input ri via a second control line RL2.

The optical coupling unit OK, which has a first and a second input i1, i2 and a first and a second output e1, e2, is connected to the fiber output fe of the optical transmission fiber OF with, for example, the fiber output fe being connected to the first input i1 of the optical coupling unit OK. The first output e1 of the optical coupling unit OK is connected via an optical transmission path fiber OUS to the input i of the optical receiving unit ORU, in which case the dashed line is intended to show the length of the optical transmission path fiber OUS which may be, for example, several hundred kilometers. Furthermore, the signal production unit SCU, which has a control input ri and an output o, is connected via a first optical coupling fiber OCF1 to the second input i2 of the optical coupling unit OK. In addition, the control unit RU, which has an input i, a first and a second output e1, e2, or its input i is connected via a second optical coupling fiber OCF2 to the second output e2 of the optical coupling unit OK.

The control unit RU has, for example, an optoelectrical converter unit OEW, an assessment unit BU and a monitoring unit CU, with the optoelectrical converter unit OEW being connected to the input i of the control unit RU, and being connected to the assessment unit BU. The assessment unit BU is connected to the monitoring unit CU and to the first and second outputs e1, e2 of the control unit RU. Furthermore, the first output e1 of the control unit RU is connected via a first control line RL1 to the control input ri of the signal production unit SCU. The second output e2 of the control unit RU is connected, as already mentioned, via the second control line RL2 to the control input ri of the controllable attenuator DGL.

A modulated, for example amplitude-modulated, optical transmission signal os is produced at a frequency F in the optical transmission unit OTU, and is emitted at the output o of the optical transmission unit OTU to the optical connecting line OVL, via which the modulated optical transmission signal os is passed on to the input i of the optical controllable attenuator DGL. The optical transmission signal os may be modulated, for example, in the form of amplitude modulation or angle modulation. The modulated optical transmission signal os may also be isolated, for example via an optical isolator in the transmission direction UER (not shown in FIG. 1).

The controllable attenuator DGL is used to attenuate the amplitude or the power level of the modulated optical transmission signal os on the basis of the second control signal rs2, which is applied to the control input ri, and the attenuated optical modulated transmission signal os is transmitted to the output e of the controllable attenuation unit or of the controllable attenuator DGL. The modulated optical transmission signal os is passed on from the output e of the controllable attenuator DGL to the fiber input fi of the optical transmission fiber OF, and is transmitted via the optical transmission path OTL.

The modulated optical transmission signal os at the output or at the fiber output fe of the optical transmission fiber OF is transmitted to the first input i1 of the optical coupling unit OK. A portion of the optical modulated transmission signal os′ is output via the optical coupling unit OK, and the major part, which for example represents 97% of the transmitted optical modulated transmission signal os, is transmitted from the first output e1 of the optical coupling unit OK via the optical transmission path fiber OUS to the input i of the optical receiving element ORU.

The output portion of the modulated optical transmission signal os′ is transmitted via the second optical coupling fiber OCF2 from the second output e2 of the optical coupling unit OK to the input i of the control unit RU. In the control unit RU, the optical transmission signal os′ received at the input i is converted via an optoelectrical converter unit OEW to an electrical signal es, which is transmitted to the assessment unit BU in the optical control unit RU. The assessment unit BU is used to determine the power level of the carrier component, or the amplitude of the carrier component Ft, of the optical modulated transmission signal os, and to establish the total power level of the optical modulated transmission signal os. In addition, the power level of the sideband signals can also be determined. In order to determine the power level of the carrier signal, the carrier component of the electrical signal es is, for example, determined via a filter unit (not illustrated) and its power level is then established. In addition, the extinction ratio, that is to say the ratio of the binary “1” signal power level to the binary “0” signal power level, of the electrical signal es is determined.

The power level of the carrier signal Ft as determined in the assessment unit BU, and the total power level of the modulated optical transmission signal os are passed on to the monitoring unit CU via assessment signals bi. In the monitoring unit CU, the assessment signals bi are processed further to form a first and a second control signal rs1, rs2. By way of example, control can be carried out on the basis of the power level of the fundamental of the assessment signals bi. The first control signal rs1, which is formed in the monitoring unit CU in the control unit RU, is transmitted from the first output e1 of the control unit RU via the first control line RL1 to the control input ri of the signal production unit SCU. The second control signal rs2, which is formed in the monitoring unit CU in the control unit RU, is transmitted from the second output e2 of the control unit RU via the second control line RL2 to the control input ri of the controllable attenuator DGL.

The controllable signal production unit SCU is controlled in order to provide optimum filtering or to reduce the carrier signal component Ft from the optical modulated transmission signal os (F, Ft), and which is used to control the frequency and power of the optical signal ps(F-ΔF), and hence to make it possible to maximize the gain of the optical signal ps(F-ΔF) in the optical transmission fiber OF via stimulated Brillouin scatter, or at the expense of the power level of the carrier signal component Ft of the modulated optical transmission signal os(F, Ft).

The first control signal rs1, formed in the control unit RU, is used in the signal production unit SCU to control the frequency and power of the optical signal ps(F-ΔF) produced in the controllable signal production unit SCU. In the case of frequency control such as this, the mathematical sign of the frequency error between the optical signal ps(F-ΔF) and the frequency F-ΔF is determined by “wobbling” (periodically varying the frequency shift by a small amount via frequency-sweep voltages), with frequency control being carried out, for example, using the “lock-in-principle” on this basis. The optical signal ps(F-ΔF) which is produced is thus at a frequency F-ΔF which represents a shift through ΔF from the frequency F of the amplitude-modulated optical transmission signal os(F). The optical signal ps(F-ΔF) is preferably at a frequency which is reduced by the Brillouin frequency shift ΔF (approximately 10 to 13 GHz) from the carrier signal frequency Ft of the optical modulated transmission signal os(F, Ft); that is, the frequency difference from ΔF is, for example, in the range 10 to 13 GHz. This frequency difference ΔF is matched to the nonlinear effect of the stimulated Brillouin scatter which is “yielded” in the method according to the present invention for improving the signal quality by reducing the carrier signal Ft in order to amplify the optical signal os(F, Ft). For this reason, the optical signal ps(F-ΔF) is transmitted from the output o of the controllable signal production unit SCU to the second input i2 of the optical coupling unit OK, using which the optical signal ps(F-ΔF) at the fiber output fe is injected into the optical transmission fiber OF in the opposite direction GUER to the transmission direction, that is to say in the opposite direction. The optical signal ps(F-ΔF) thus propagates in the opposite direction to the optical modulated transmission signal os(F, Ft) in the optical transmission fiber OF.

The optical signal ps(F-ΔF) which is injected at the fiber end fe of the optical transmission fiber OF is used to reinforce the nonlinear effect of stimulated Brillouin scatter in the optical transmission fiber OF as a result of which, according to the present invention, the carrier signal component Ft of the modulated optical transmission signal os(F, Ft) is reduced owing to the stimulated Brillouin scatter in order to amplify the optical signal ps(F-ΔF), that is to say the carrier signal component Ft of the optical modulated transmission signal os(F, Ft) is reduced, this resulting in a higher extinction ratio for the optical modulated transmission signal os(F, Ft).

Instead of the optical transmission fiber OF, an optical special fiber with high efficiency and a low line width with regard to the stimulated Brillouin scatter can also be provided (not shown in FIG. 1).

Furthermore, the controllable attenuator DGL is controlled via the second control signal rs2, which is formed in the control unit RU, such that the power level or amplitude of the modulated optical transmission signal os(F, Ft) is at an optimum level with regard to the reduction in the carrier signal component Ft. By way of example, with an optical modulated NRZ transmission signal, the carrier signal component and the two sideband signals are ideally at virtually the same power level. This avoids, in particular, the amplitude or the power level of the modulated optical transmission signal os(F, Ft) exceeding the critical signal power level required for the onset of the nonlinear effect of stimulated Brillouin scatter. Analogously to this, the optical transmission unit OTU could also be controlled via the second control signal rs2, so that the critical signal power level required for the onset of stimulated Brillouin scatter is not exceeded even in the optical transmission unit OTU by the signal power level of the optical transmission signal os(F, Ft) which is produced.

In addition, in order to control the frequency of the optical signal ps via, for example, the first control signal rs1, the frequency difference between the carrier signal Ft and the optical signal ps is determined in the monitoring unit CU, and is controlled with regard to the Brillouin shift ΔF to be produced.

The signal power level of controllable optical signal production units SCU, in particular laser units, can be controlled only to a limited extent with, for example, power level changes of about 10 dB being feasible. Thus, in order to allow a higher effective power bandwidth to be used, it is necessary to be able to attenuate the power level of the optical transmission signal os(F, Ft) via the controllable attenuator DGL. The combination of the controllable optical signal production unit SCU and the controllable optical attenuator DGL allows the filtering or reduction of the carrier component according to the present invention to be optimized.

The effect of reducing the carrier signal component Ft of the optimum modulated transmission signal os(F, Ft) can thus be regarded as filtering with a narrowband optical filter making use of stimulated Brillouin scatter and, for example, having a bandwidth of less than 100 MHz, and whose mid-frequency and insertion loss can be controlled via the control unit RU.

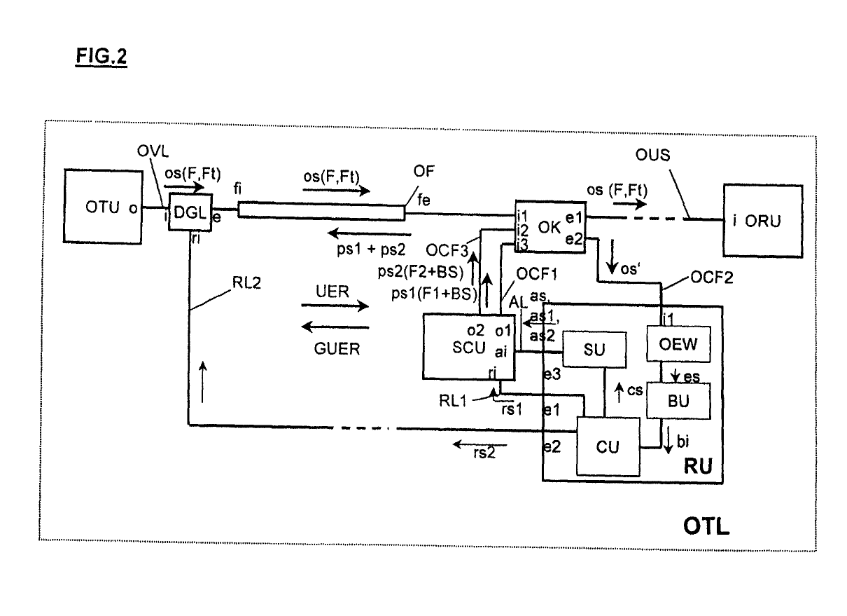

FIG. 2 shows a further refinement of the method according to the present invention, in this case with an optical transmission path OTL being used for transmitting the modulated optical transmission signal os(F, Ft), in which, in contrast to the first exemplary embodiment, a first and a second optical pump signal ps1(F1+BS), ps2(F2 +BS), for example, are injected in the opposite direction GUER to the transmission direction at the fiber output fe of the optical transmission fiber OF. To do this, the optical coupling unit OK illustrated in FIG. 2 has a second and a third input e2, e3, via which the first and second optical pump signals ps1(F1+BS), ps2(F2+BS) produced in the signal production unit SCU are injected into the optical fiber OF. In addition, a signal unit SU is provided in the control unit RU, in order to produce drive signals as, as1, as2. The other units and blocks illustrated in FIG. 2 correspond to those in the exemplary embodiment illustrated in FIG. 1.

In the exemplary embodiment illustrated in FIG. 2, the first and second optical pump signals ps1(F1+BS), ps2(F2+BS), which are likewise produced in the signal production unit SCU, are fed in via the optical coupling unit OK at the fiber output fe of the optical transmission unit OF in the opposite direction GUER to the transmission direction. The first and second optical pump signals ps1(F1+BS), ps2(F2+BS) are at frequencies which are higher than the frequencies F1, F2 of the first sideband LSB, USB (which is symmetrical with respect to the carrier signal) by the Brillouin frequency shift BS (approximately 10 to 13 GHz). The frequencies of the first and second optical pump signals ps1(F1+BS), ps2(F2+BS) is, for example, varied within the frequencies of the lower and upper first sideband or sideband signals LSB′, USB′, which is increased by the Brillouin frequency shift or Brillouin shift BS. That is, the frequency of the first or second optical pump signals ps1(F1+BS), ps2(F2+BS) passes through the complete frequency band of the respective upper or lower sideband LSB′, USB′ within a time interval t2. The first and second optical pump signals ps1(F1+BS), ps2(F2+BS) are thus intended to amplify the first sideband signals LSB, USB of the optical transmission signal os(F, Ft) by utilizing the nonlinear effect of stimulated Brillouin scatter. For this purpose, for example, the first optical pump signal ps1(F1+BS), which amplifies the lower sideband LSB, passes through the lower sideband LSB′, increased by the Brillouin shift BS, with a repetition frequency of approximately 10 KHz. That is, the first optical pump signal ps1(F1+BS) assumes all the frequencies from the lowest frequency of the lower sideband LSB′ to the highest frequency of the lower sideband LSB′ within the period t1.

Analogously to the control system in FIG. 1, the frequency and power level of the injected first and second optical pump signals ps1(F1+BS), ps2(F2+BS) are, in turn, controlled via the control unit RU, thus achieving the optimum gain for the lower and upper sidebands LSB, USB of the modulated optical transmission signal os(F, Ft) on the basis of the stimulated Brillouin scatter formed in the optical transmission fiber OF. To do this, the total power level and the extinction ratio of the electrical signal es are determined in the assessment unit BU, and are supplied to the monitoring unit CU in the form of assessment signals bi. A first and a second control signal rs1, rs2 are, in turn, formed in the monitoring unit CU via the assessment signals bi, and are transmitted to the controllable optical signal production unit SCU and, respectively, to the controllable attenuator DGL.

In addition to the production, for example, of a drive signal as or of a first and second drive signal as1, as2 in the controllable optional signal production unit SCU, this unit has a signal unit SU, which is connected to the monitoring unit CU and to the third output e3 of the control unit RU. In a corresponding manner, the third output e3 of the control unit RU is connected via a drive line AL to the drive input ai of the signal production unit SCU.

Once the assessment signals bi have been evaluated in the monitoring unit CU, the production of the drive signals as, as1, as2 in the signal unit SU is controlled via control signals cs which are formed in the monitoring unit CU, and the drive signals as, as1, as2 formed in the signal unit SU are thus matched to the determined operating state of the optical transmission path OTL. The first and second drive signals as1, as2 are transmitted via the third output e3 and the drive line AL to the drive input ai of the signal production unit SCU. The frequencies F1, F2 of the first and second optical pump signals ps1(F1+BS), ps2(F2+BS) are thus varied in accordance with the first and second drive signals as1, as2, in the signal production unit SCU.

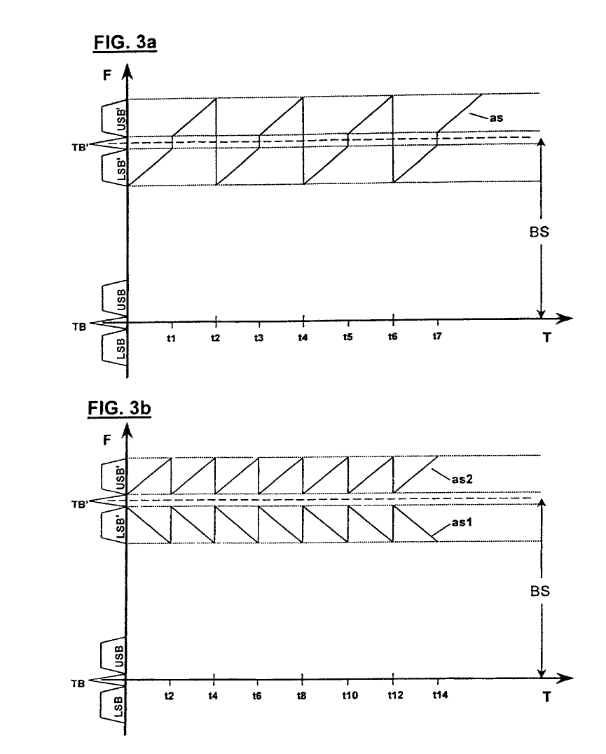

FIGS. 3a and 3b both use a graph to show possible drive signals as, as1, as2, with FIG. 3a showing a single drive signal as for varying the frequency of just one optical pump signal ps, and FIG. 3b showing a first and a second drive signal as1, as2 in order to vary the frequencies of a first and a second optical pump signal ps1, ps2 separately. Time T is plotted on the abscissa of the graphs and the frequency F is plotted on the ordinate, that is to say the graphs show the variation of the frequency F with time T. In addition, the zero point on the ordinate F is located at the carrier frequency Ft of the optical modulated transmission signal os(F, Ft), whose lower and upper first sidebands LSB, USB are indicated via small trapezoidal boxes in FIGS. 3a and 3b. The lower and upper first sidebands LSB′, USB′, increased by the Brillouin frequency shift BS, are shown in a corresponding manner on the abscissa, separated by the separation for the Brillouin frequency shift BS.

The drive signal as illustrated in FIG. 3a has a “sawtooth” profile. The drive signal as rises linearly, by way of example, from the lowest frequency of the lower sideband LSB′, increased by the Brillouin shift BS, to the highest frequency of the lower sideband LSB′, increased by the Brillouin BS, jumps over the carrier signal frequency band TB′, likewise increased by the Brillouin shift BS, and continues the linear rise from the lowest frequency to the highest frequency for the upper sideband USB′ increased by the Brillouin shift BS. This process of passing through the lower and upper increased sidebands LSB′, USB′ requires, for example, a time period of t1+t2, which, by way of example, is in the order of 10⁻⁴ seconds. After reaching the highest frequency of the upper sideband USB′ increased by the Brillouin shift BS, the drive signal as assumes the initial value, that is to say the lowest frequency of the lower sideband LSB′ increased by the Brillouin shift BS, and once again rises linearly. A drive signal as such as this is used to sweep the frequency of the optical pump signal ps(F, BS) periodically over the frequency range required to amplify the lower and upper sidebands LSB, USB of the optical modulated transmission signal os(F, Ft).

Analogously to this, when using a first and a second optical pump signal ps1(F1, BS), ps2(F2, BS), a first and a second optical drive signal as1, as2 are used to vary the frequencies of the first and second optical pump signals ps1(F1, BS), ps2(F2, BS) separately, as is shown by way of example in FIG. 3b. The first drive signal as1 falls linearly from the highest frequency of the lower sideband LSB′, increased by the Brillouin shift BS, to the lowest frequency of the lower sideband LSB′, increased by the Brillouin shift BS, within the time interval t2. Following this, the first drive signal as1, in turn, assumes its start value, that is to say the highest frequency of the lower sideband LSB′ increased by the Brillouin shift BS, and then falls linearly once again. This, therefore, also results in the first drive signal as1 having a sawtooth structure. The second drive signal as2 has a profile which is symmetrical with respect to the increased carrier signal frequency band TB′, that is to say the second drive signal as2 rises linearly from the lowest frequency to the highest frequency of the upper sideband USB′, increased by the Brillouin shift BS. After passing through the increased upper sideband USB′, the second drive signal as2 is reset to the start value from the time t2, and continues to follow the illustrated profile on a cyclic basis.

The “sawtooth” profile of the drive signals as, as1, as2 illustrated in FIGS. 3a and 3b leads, since the characteristic is virtually constant in the frequency domain, to a virtually constant gain for the first sideband signals, or the first sidebands, LSB, USB. However, the gain spectrum can be varied by deliberately shaping the profile of the drive signals as, as1, as2, so that, for example, the cut-off frequencies of the first sideband LSB, USB may be amplified to a greater extent than the mid-frequencies in the first sideband LSB, USB. The method according to the present invention is, thus, in no way restricted to “sawtooth” drive signals as, as1, as2, but can be carried out via drive signals as, as1, as2 having any desired profiles.

Although the present invention has been described with reference to specific embodiments, those of skill in the art will recognize that changes may be made thereto without departing from the spirit and scope of the invention as set forth in the hereafter appended claims.

1. A method for improving signal quality of a modulated optical transmission signal having a carrier signal, the method comprising the steps of:
producing in a signal production unit at least one optical signal whose frequency is reduced from a frequency of the carrier signal by a Brillouin frequency shift; and
injecting the at least one optical signal into the optical transmission fiber in an opposite direction to a transmission signal direction so that the carrier signal of the modulated optical transmission signal is reduced.

2. A method for improving signal quality of a modulated optical transmission signal having a carrier signal as claimed in claim 1, wherein the optical signal which is produced is injected with a power level which is below a critical SBS threshold power level.

3. A method for improving signal quality of a modulated optical transmission signal having a carrier signal as claimed in claim 1, wherein the optical signal is produced in the signal production unit which is arranged such that it is physically separated from the optical transmission unit provided for producing the optical transmission signal.

4. A method for improving signal quality of a modulated optical transmission signal having a carrier signal as claimed in claim 1, the method further comprising the step of:
measuring a frequency difference between the carrier signal and the optical signal, and controlling the frequency of the optical signal as a function of the measurement.

5. A method for improving signal quality of a modulated optical transmission signal having a carrier signal as claimed in claim 1, the method further comprising the step of:
varying both the frequency and the power level of the optical signal and controlling them to produce a maximum extinction ratio for the modulated optical transmission signal.

6. A method for improving signal quality of a modulated optical transmission signal having a carrier signal as claimed in claim 1, the method further comprising the step of:
attenuating the modulated optical transmission signal via an optical attenuator before being injected into the optical transmission fiber.

7. A method for improving signal quality of a modulated optical transmission signal having a carrier signal as claimed in claim 6, the method further comprising the step of:
measuring the power level of the carrier signal of the modulated optical transmission signal, and controlling the attenuation response of the attenuator as a function of the measurement.

8. An apparatus for improving signal quality of an optical transmission signal which is produced in an optical transmission unit, is modulated, has a carrier signal and is transmitted via an optical transmission fiber, the apparatus comprising:
a signal production unit for producing an optical signal whose frequency is reduced from a frequency of the carrier signal by a Brillouin frequency shift;
an optical coupling unit for outputting a portion of the transmitted optical modulated transmission signal and for injecting the optical signal into the optical transmission fiber in an opposite transmission direction, the injected optical signal reducing the carrier signal of the modulated optical transmission signal; and
a control unit for determining a power level of the carrier signal of the modulated optical transmission signal and for forming at least one control signal, the frequency and power level of the optical signal produced by the signal production unit being controlled via the at least one control signal which is formed.

9. An apparatus for improving signal quality of an optical transmission signal which is produced in an optical transmission unit, is modulated, has a carrier signal and is transmitted via an optical transmission fiber as claimed in claim 8, further comprising:
an optical attenuator positioned upstream of the optical transmission fiber for attenuating the modulated optical transmission signal before it is injected into the optical transmission fiber.

10. A method for improving the signal quality of a modulated optical transmission signal having a carrier signal, the method comprising the steps of:
producing at least one optical pump signal in a signal production unit whose frequency is varied over those frequencies of a first sideband of the optical modulated transmission signal which are located symmetrically with respect to the carrier signal and are increased by a Brillouin frequency shift, the at least one optical pump signal not assuming any of those frequencies in a carrier signal frequency band which are increased by the Brillouin frequency shift; and
injecting the at least one optical pump signal into the optical transmission fiber in an opposite direction to a transmission signal direction so that the first sideband signals of the modulated optical transmission signal are amplified.

11. A method for improving the signal quality of a modulated optical transmission signal having a carrier signal as claimed in claim 10, the method further comprising the step of:
producing a first and a second optical pump signal in the signal production unit for separate amplification of the first upper and lower sidebands located above and below the carrier signal frequency band, the frequency of the first optical pump signal being varied over the frequencies of the lower first sideband and the frequency of the second optical pump signal being varied over the frequencies of the upper first sideband.

12. A method for improving the signal quality of a modulated optical transmission signal having a carrier signal as claimed in claim 10, the method further comprising the step of:
varying the frequencies of the optical pump signals via drive signals which are produced in the control unit and have a repetition frequency which is at least in a kilohertz band.

13. A method for improving the signal quality of a modulated optical transmission signal having a carrier signal as claimed in claim 10, wherein the optical transmission signal is amplitude-modulated before transmission.

14. A method for improving the signal quality of a modulated optical transmission signal having a carrier signal as claimed in claim 10, wherein the optical transmission signal is angle-modulated before transmission.

15. A method for improving the signal quality of a modulated optical transmission signal having a carrier signal as claimed in claim 10, the method further comprising the step of:
providing, instead of the optical transmission fiber, an optical special fiber having high effeciency and low line width with regard to the stimulated Brillouin scatter.
